(19) United States
(12) Patent Application Publication
(10) Pub. No.: US 2011/0106566 A1
(43) Pub. Date: May 5, 2011

(54) ON-LINE, ON-DEMAND RESOURCE, TRAINING AND CERTIFICATION PORTAL FOR REGULATORY COMPLIANCE IN HEALTHCARE COMMUNICATIONS

(75) Inventor: Ilyssa Levins, New York, NY (US)

(73) Assignee: THE CENTER FOR COMMUNICATION COMPLIANCE, LLC, New York, NY (US)

(21) Appl. No.: 12/999,192

(22) PCT Filed: Jun. 24, 2009
(86) PCT No.: PCT/US09/48421

§ 371 Date: Dec. 15, 2010

Related U.S. Application Data
(60) Provisional application No. 61/132,919, filed on Jun. 24, 2008.

(51) Int. Cl. G06Q 50/00

(52) U.S. Cl. 705/3

(57) ABSTRACT

A computer program product comprising a computer-readable medium having computer readable program code embodied in said medium for causing a computer to execute via an online portal a method of certification organization comprising, displaying questions regarding regulations and policies related to healthcare communications; displaying questions regarding communications materials related to healthcare communications; receiving answers; determining the percentage of correct answers; determining based on the percentage of correct answers if that percentage corresponds to a passing grade, as well as a method of identifying and filling gaps in creating a culture of compliance with healthcare communications regulations and policies in an organization, a method for accessing information related to healthcare communication, a method for publishing industry benchmark reports, and a method for making grants.

### CROSS-REFERENCE TO RELATED APPLICATIONS

This application claims priority under 35 U.S.C. §119(e) to Provisional Application No. 61/132,919, filed Jun. 24, 2008, the disclosure of which is herein incorporated by reference in its entirety.

### FIELD OF THE INVENTION

The present invention relates to an on-line, on-demand resource, training and certification portal that supports healthcare communications professionals, for example, those involved in the promotion of drugs or devices (on both the client side and agency side), in their understanding of and compliance with regulatory guidelines through a strategically integrated set of services and products.

### BACKGROUND OF THE INVENTION

Many industries are facing difficulty in their need to comply with regulatory guidelines. For example, the pharmaceutical, biotech and medical device industries face intensifying pressure from government agencies, trade groups and industry/medical associations to comply with regulatory guidelines. In fact, these agencies in recent years have increased the requirements for currently marketed and investigational drugs and medical devices. The Office of the Inspector General (OIG) in the Department of Health and Human Services (HHS) and the Department of Justice (DOJ) are scrutinizing communications regarding these products. There are also regulations from the Food and Drug Administration (FDA), as well as guidelines from the Pharmaceutical Research and Manufacturers of America (PhRMA) and the Accreditation Council for Continuing Medical Education (ACCME). The consequences of non-compliance are high and can include criminal prosecution and fines, warning letters, corporate integrity agreements and placement on the OIG List of Excluded Individuals/Entities (LEIE).

With all this at stake, there is a substantial need in the field of healthcare communications for a centralized, single source hub for facilitating the learning, understanding and compliance of professional dealing with the regulatory requirements for drug and device promotion when designing, reviewing, approving, executing and overseeing communications initiatives and when offering counsel to clients.

In addition, there is currently no certification program to confirm that healthcare communications professionals involved in the design, counsel and execution of promotional materials and programs for drug and device companies are qualified in regulatory compliance. Therefore, there is a need to standardize the way to confirm that healthcare communications professionals, such as those involved in promoting drugs and devices, are competent and qualified in this area. There is training available to these professionals, however, which is costly and non-standardized. Thus, standardized training must be made available.

There also are miscellaneous reference sources, but none synthesizes the information to ensure easy use and relevance for the healthcare communications professional. Likewise, there are publications and reports, but not solely focused on the needs of communications professional working at healthcare communications agencies, specially those involved in the promotion of drugs and devices.

Also, no for-profit organization is providing grants to further the education in regulatory compliance of healthcare communications professionals.

The present invention accordingly provides a novel one-stop on-line, on-demand resource, training and certification hub (portal) that supports healthcare communications professionals involved, for example, in the design, counsel and execution of material and programs for drug and device promotion (client and agency side) in their understanding of and compliance with regulatory guidelines in a unique configuration and format.

### SUMMARY OF INVENTION

The present invention provides such a web-based hub that supports healthcare communications professionals, such as those involved in the design, counsel and execution of materials and programs for drug and device promotion (on both the client side and the agency side) in the understanding of and compliance with regulatory guidelines through a strategically integrated set of services and products in a unique configuration and format. Preferably the products and services are selected from, include any combination of or include all of the following six products and services.

### Certification Organization

Advertising, PR, promotional medical educational, and managed care professionals

### Training Provider

Standardized and customized training via Web casts and Web X teleconferences
Also allows hosting of other providers with related services

### Reference Source and Library

Resource Center with links to relevant sites, articles, presentations, and best practices that are organized in user-friendly categories and have industry relevance

### Consultant

Online tools such as internal material audits and guidelines for creating a culture of compliance within an organization
Also allows hosting of other providers with related services

### Publisher

Benchmarking Reports
Enduring materials including newsletters, books and DVDS
Also allows hosting of other providers with related services

### Foundation

Grant-making to third party organizations, including but not limited to: universities and industry and professional associations.

In combination with the informational access, the web site hub will provide a certification test to evaluate competency in the real-world application of regulatory guidelines. The certification testing will certify regulatory competence for the United States, global programs or both.

### BRIEF DESCRIPTION OF THE DRAWINGS

FIG. 1 illustrates the steps according to one embodiment of a computer-readable medium having computer readable program code for causing a computer to execute via an online portal a method of certification organization.

FIG. 2 illustrates a an online portal system according to one embodiment containing information resources related to healthcare communications.

### DETAILED DESCRIPTION OF THE PRESENT INVENTION

The present invention provides communications professionals involved in the design, counsel and execution of materials and programs for drug and device promotion in the health care industries with current, practical and essential information on regulatory compliance from a central source, that preferably will allow the industry to set and maintain high standards in this critical area. Pharmaceutical, biotechnology and medical device clients insist that communications professionals in public relations, medical education, advertising and managed care responsible for drug and device promotion be knowledgeable about regulatory compliance.

In accordance with at least one embodiment, the online portal of the present invention preferably provides access to at least six integrated offerings that are accessible in user-friendly and industry relevant formats. The method of linking and programming are not the subject of the present invention, rather it is the unique combination of resources into a centralized online portal to provide easy and efficient access to a unique combination of information. The methods of linking and other software for providing the certifications are considered within the knowledge of those of ordinary skill in the art.

### 1. Certification Organization

The first required element of the present invention is that the web site provides access to a Certification Test. The test is an advantageous portion of the present invention as it will provide assurance that the certified professionals are qualified to design, execute and oversee regulatory compliance promotion, increase the credibility of the healthcare promotional practices, reduce violation of compliance regulations in health care promotion, and provide an opportunity to set new industry standards. In this regard, the certification test pursuant to the present invention is developed by a well respected educator and reviewed by leaders in the field, including at least, but not limited to former FDA officials and external legal counsel.

While the test can certify compliance at a variety of levels, it is presently contemplated that the web site provide certification of regulatory compliance at two levels, basic and advanced. For Basic Certification, the professional needs to complete two parts of a three part test, namely Regulations and Policies (Part I) and Communications Materials (Part II). For the Advanced Certification, in addition to Parts I & II, the individual would need to also pass Scenarios (Part III). The test contents would include the basics on phases of approval; review of regulatory bodies and their governing power; fines and penalties for non-compliance and how-tos on tactics such as:
(a) Public Relations: press releases, VNR/RNR (video news release/audio news release), camera ready articles, celebrities; interface with advocacy groups and other appropriate tactics for this practice
(b) Advertising: ads, detail aids, sales rep training materials, direct mail campaigns and other appropriate tactics for this practice
(c) Promotional Medical Education: speakers bureaus, consultant meetings, supplements, presentations and publications, and other appropriate tactics for this practice
(d) Managed Care: contracting with physicians, development of educational programs
(e) Drug Development 101: general understanding of the regulations and processes involving drug development around the world
(f) Core Global Programming: general understanding of the regulations and processes involving drug development around the world

The first portion of the test can be in any form, but preferably it comprises true/false questions, multiple choice questions or a combination thereof. In preferred embodiments, there would be from 10 to 30 questions and there would be from 20 minutes to an hour to complete the test, such as a test of 25 questions and 30 minutes to complete the test. In preferred embodiments, the test is self grading (using software and such as are known to those skilled in the art). A passing grade of, for example, 80%, enables the user to proceed to the second part of the test.

The second part of the test confirms the competency of the individual in the development and execution of communications materials within regulatory guidelines and covers those listed above.

The second portion of the test can be in any form, but preferably it comprises true/false questions, multiple choice questions or a combination thereof. In preferred embodiments, there would be from 10 to 30 questions and there would be from 20 minutes to an hour to complete the test, such as a test of 25 questions and 30 minutes to complete the test. In preferred embodiments, the test is self grading (using software and such as are known to those skilled in the art). A passing grade of, for example, 80%, enables the user access to a Certification Link, from which they are able to receive a Printed Certification of having passed the Basic Test.

Once having passed the Basic Test, the user then would have access to the third portion of the test, which certifies Advanced Regulatory Competency. This includes, but is not limited to, mastery of the application of regulatory guidelines to complex PR, advertising, promotional medical education and managed care scenarios with multiple factors at play. The third part of the test includes topics such as, but not limited to, one or more of: (a) advocacy group relationships; (b) speaker's bureaus and publication strategies; c) off-label communication around medical meetings; and (d) communications in support of clinical trials.

The third portion of the test can be in any form, but preferably it comprises true/false questions, multiple choice questions, or a combination thereof. Preferably for this portion of the test, only multiple choice questions are involved. In preferred embodiments, there would be from 10 to 30 questions and there would be from 20 minutes to an hour to complete the test, such as a test of 25 questions and 30 minutes to complete the test. In preferred embodiments, the test is self grading (using software and such as are known to those skilled in the art). A passing grade of, for example, 80%, enables the user access to a Certification Link, from which they are able to receive a Printed Certification of having passed the Advanced Regulatory Competency test.

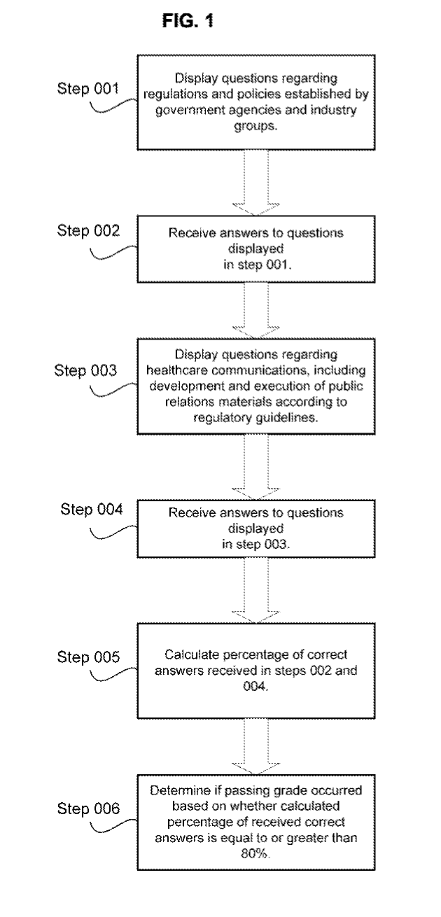

FIG. 1 illustrates the steps of a computer-readable medium having computer readable program code for causing a computer to execute via an online portal a method of certification organization. The computer-readable medium can be any such medium capable of executing computer readable program code including, without limitation, a personal computer. In one embodiment, a user accesses the method of certification organization, (hereinafter the “Certification Test”) via the internet. FIG. 1 illustrates a method that displays questions related to public relations and healthcare communications, for example, communications related to drug and device promotion, that tests a user's basic regulatory competency in the essentials of regulatory compliance. In step 001, the online portal displays questions regarding regulations and policies related to health care communications (e.g., related to drug and device promotion). This portion of the test displays questions that test the user's knowledge of the regulations and policies established by government agencies and industry groups related to healthcare public relations. In step 002, the online portal receives answers to the respective questions displayed in step 001. In alternate embodiments, one or more questions are displayed for a predetermined time in step 001 until one or more answers to the displayed questions are received in step 002. In step 003, the online portal displays questions regarding communications related to healthcare communications. This portion of the test displays questions that test the user's competency in the development and execution of public relations materials and programs within regulatory guidelines. In step 004, the online portal receives answers to the respective questions displayed in step 003. After all the questions displayed in both steps 001 and 003 are displayed, and all the respective answers to those questions are received in step 002 and 004, then in step 005, a determination is made that calculates, based on the tabulated number of correct and incorrect answers to the foregoing questions, the percentage of questions for which correct answers were received. Then in step 006, a determination is made as to whether, based on the percentage of correct answers received in steps 002 and 004, whether a passing grade has occurred. In one embodiment, a passing grade constitutes a percentage calculated in step 005 that is equal to or greater than 80%. In alternate embodiments, additional steps comprise displaying additional questions and receiving answers to those questions, which together with the answers received in steps 002 and 004, contribute to make the percentage of correct answers received and whether a passing grade occurs. In these alternate embodiments, the additionally displayed questions regarding scenarios related to healthcare communications including, without limitation, questions that test the user's mastery of the application of regulatory guidelines to complex public relations scenarios with multiple factors at play. In alternate embodiments, additional displayed questions also cover such topics as advocacy groups relationships, off-label communication around medical meetings, communications in support of clinical trials, and investor relations.

In alternate embodiments, questions are displayed steps 001 and 003 and any required additional steps of displaying questions that relate to advertising promotion (e.g., drug or device promotional communications) that certifies a user's basic regulatory competency in the essentials of regulatory compliance for healthcare advertising. In one embodiment, questions are displayed in a first step that test a user's knowledge of the regulations and policies established by government agencies and industry groups regarding advertising related to, for example, drug and device promotion, and questions are displayed in a different step that test a user's competency in the development and execution of advertising materials within regulatory guidelines. In an alternate embodiment, an additional step displays questions that test a user's mastery of the application of regulatory guidelines to complex advertising scenarios with multiple factors at play, and an additional step that displays questions covering topics including, without limitation, sales aids, advertisements for drugs with boxed warnings, patient brochures, use of market research in ads, and spokespersons. In alternate embodiments, each of the foregoing steps of displaying questions regarding the foregoing healthcare communications advertising topics are coupled, interlaced, or followed by, in alternate embodiments, steps of receiving answers to the respective questions, which are followed by a step of determining the percentage of correct received answers and a step of determining whether, based on the determined percentage of correct received answers, a passing grade has occurred.

In alternate embodiments, questions are displayed in steps 001 and 003 and any required additional steps of displaying questions that relate to promotional medical education and healthcare communications that certifies a user's basic regulatory competency in the essentials of regulatory compliance for promotional medical education. In one embodiment, questions are displayed in a first step that test a user's knowledge of the regulations and policies established by government agencies and industry groups related to promotional medical education, and questions are displayed in a different step that test a user's tests competency in the development and execution of promotional medical education materials within regulatory guidelines. In an alternate embodiment, an additional step displays questions that test a user's mastery of the application of regulatory guidelines to complex promotional medical education scenarios with multiple factors at play and an additional step that displays questions covering topics as presentations at medical society conferences, speaker training and fees, key opinion leaders, and use of consultants for program development. In alternate embodiments, each of the foregoing steps of displaying questions regarding the foregoing healthcare communications advertising topics are coupled, interlaced, or followed by, in alternate embodiments, steps of receiving answers to the respective questions, which are followed by a step of determining the percentage of correct received answers and a step of determining whether, based on the determined percentage of correct received answers, a passing grade has occurred.

### 2. Trainer Provider

### Standardized and Customized Training

The present invention further offers web-based training seminars taught by leaders in the field. Teaching sessions contain both lecture material and a Q&A segments. It is further contemplated that the present invention may provide follow-on training at a more advanced level, or in specific regulatory areas where firms need additional customized education.

### 3. Reference Source and Library

The present invention also will provide a comprehensive resource center—a central source of regulatory compliance information, guidelines, standards, and best practices for healthcare communications professionals.

The Resource Center portion of the present invention serves healthcare communication professionals, e.g., those involved in drug and device promotion, as an expert central source for knowledgeably responding to clients' and colleagues' questions in the regulatory arena. In addition to supplying the basic knowledge required to do the job well and keeping the professional up-to-speed, it is a source of Regulatory Compliance expertise and source documents for handling common communication situations.

Specifically, resources include: Common communications situations basic library of key documents, articles, books & manuals, presentations, regulatory body & guidelines, industry groups & guidelines, professional organizations and guidelines, industry newsletters, and News & Events
Examples of links to regulatory bodies and guidelines include:
FDA Sites: http://www.fda.gov, http://www.fda.gov/cder/warn/index.htm, http://www.fda.gov/cder/ddmac/lawsregs.htm, http://www.access.gpo.gov/nara/cfr/waisidx_{—}01/21cfr202_{—}01.html, http://www.accessdata.fda.gov/scripts/w1cfm/sindex.cfm http://www.accessdata.fda.gov/scripts/w1cfm/cindex.cfm http://www.fda.gov/cber/efoi/adpromo.htm

### OIG (Office of the Inspector General of HHS)

### ACCME (Accreditation Council for Continuing Medical Education)

Examples of industry groups include:

### PhRMA (Pharmaceutical Research and Manufacturers of America)

### Advanced Medical Technology Association (AdvaMed)

### Food and Drug Law Institute (FDLI), Drug Information Association (DIA)

### Regulatory Affairs Professionals Association (RAPS)

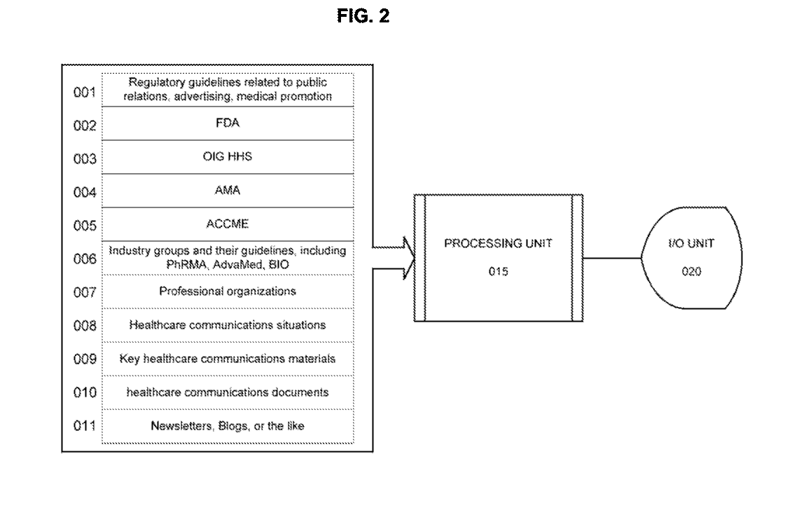

FIG. 2 illustrates an online portal system containing information related to healthcare communications according to one embodiment. In one embodiment, the information is contained in a database, and the database comprises a library with a plurality of individual sub-libraries, or resources. In one embodiment, the online portal provides a user access via hypertext links that are displayed to each of the individual resources. FIG. 2 illustrates resources covering topics related to regulatory compliance, including regulations, policies, guidelines, publications, books, articles, presentations, and original content. In alternate embodiments, one or more of the individual resources are periodically updated with additional or revised material pertinent to the subject matter of each individual resource.

Turning to FIG. 2, resource 001 contains information that explains, without limitation, Food and Drug Administration (FDA), FTC and other regulatory guidelines related to public relations, advertising, and medical promotion of healthcare-related topics and healthcare communications. Resource 002 contains information related to providing healthcare communication professionals with critical information from the FDA. Resource 003 contains hypertext links related to the Office of Inspector General (OIG) of Health and Human Services (OIG HHS), as well as related information. Resource 005 contains information related to the American Medical Association (AMA). Resource 006 contains information related to the Accreditation Council for Continuing Medical Education (ACCME). Resource 007 contains information related to industry groups and their guidelines, including, without limitation, the Pharmaceutical Research and Manufacturers of America (PhRMA), the Advanced Medical Technology Association (AdvaMed), the Biotechnology Industry Organization (BIO), and others. Resource 008 contains information related to professional organizations, including, without limitation, the Food and Drug Law Institute, the Drug Information Association, the Regulatory Affairs Regulatory Association, and others. Resource 009 contains information related to common healthcare communications situations, which includes information, without limitation, related to establishing a culture of compliance in an agency, developing compliant materials, understanding the risks of non-compliance, and promoting clinical trials and communicating trial results. Resource 010 contains information related to key documents for healthcare communications professionals including, without limitation, FDA regulations, PhRMA Code, AdvaMed Code, OIG Compliance Guidelines, sample Corporate Integrity Agreements from the OIG, ACCME Guidelines, and AMA Guidelines. Resource 011 contains industry newsletters and blogs for healthcare communications professionals. Processing unit 015 is configured to access one or more of the individual resources 001 to 011 in the database via user interface unit 020 that interactively provides user access to the above-described resources, and presents concrete, useful and tangible results to health professionals and the like.

### 4. Consultant

The present invention preferably also will provide diverse online tools such as internal material audits and guidelines for creating a culture of compliance within an organization. These tools will be both free of charge and/or will require payment from the customer.

In other preferred embodiments of the present invention, the portal will also provide discounted access to expert consultants with top regulatory and legal expertise. The agenda can be determined by the client, including questions related to the certification test, a client's regulatory situation, a recently announced policy decision, execution of specific tactics, etc

### 5. Publisher

The present invention preferably also contemplates the publishing of industry benchmark reports that address:
How is the industry as a whole doing in regard to regulatory compliance knowledge?
What are the specific knowledge areas in regulatory compliance of greatest strength/weakness in the industry? What areas did people have the most/least trouble with? Where are the “knowledge gaps (deficiencies)”?
How are people in the industry doing in regard to Basic/Advanced levels of competency from the perspective of job level (in their agencies)? From the perspective of agency size?
Trending data re: What are any new regulatory compliance issues challenging healthcare PR professionals involved in drug and device promotion—allows us tracking of year-to-year trend lines in regard to perennial and emerging (or fading away) issues
   Other preferred publications may include publish glossary of terms, books and DVDs, and original content newsletters on the subject of regulatory compliance and other related issues.

### 6. Foundation

The portal of the present invention preferably also will be capable of providing information to facilitate the making grants to third party organizations, including but not limited to: universities and industry and professional associations.

What is claimed is:

1. A computer program product comprising a computer-readable medium having computer readable program code embodied in said medium for causing a computer to execute via an online portal a method of certification organization, comprising:
a step of displaying questions regarding regulations and policies related to healthcare communications;
a step of receiving answers to the questions regarding regulations and policies related to healthcare communications;
a step of displaying questions regarding communications materials related to healthcare communications;
a step of receiving answers to the questions regarding communications materials related to healthcare communications;
a step of determining the percentage of correct answers;
a step of determining based on the percentage of correct answers if that percentage corresponds to a passing grade.

2. A computer program product as claimed in claim 1,
wherein the step of displaying questions regarding regulations and policies related to healthcare communications displays a predetermined number of questions.

3. A computer program product as claimed in claim 1,
wherein the step of displaying questions regarding communications materials related to healthcare communications displays a predetermined number of questions.

4. A computer program product according to claim 1,
wherein the step of receiving answers to the questions regarding regulations and policies related to healthcare communications terminates after a predetermined period of time.

5. A computer program product according to claim 1,
wherein the step of receiving answers to the questions regarding communications materials related to healthcare communications terminates after a predetermined period of time.

6. A computer program product according to claim 1,
wherein a passing grade corresponds to a percentage of correct answers equal to or greater than 80 percent.

7. A computer program product according to claim 1, further comprising:
a step of displaying questions regarding scenarios related to healthcare communications; and
a step of receiving answers to the questions regarding scenarios related to healthcare communications.

8. A computer program product according to claim 7,
wherein the step of displaying questions regarding scenarios related to healthcare communications terminates after a predetermined period of time.

9. A computer program product according to claim 7,
wherein the step of receiving answers to the questions regarding scenarios related to healthcare communications terminates 20 minutes to 60 minutes.

10. A computer program product according to claim 7,
wherein a passing grade corresponds to a percentage of correct answers equal to or greater than 80 percent.

11. A computer program product according to claim 1,
wherein the questions regarding regulations and policies related to healthcare communications and the questions regarding communications materials related to healthcare communications comprise true/false questions, multiple choice questions or a combination thereof.

12. A computer program product according to claim 7,
wherein the questions regarding scenarios related to healthcare communications comprise true/false questions, multiple choice questions or a combination thereof.

13. A computer program product according to claim 1,
wherein the questions regarding regulations and policies related to healthcare communications and the questions regarding communications materials related to healthcare communications comprise questions regarding the basics on phases of approval, review of regulatory bodies and their governing power, fines and penalties for non-compliance or how-tos on tactics comprising: public relations, advertising, medical education, and compliance officers/regulatory and legal professionals.

14. A computer program product according to claim 7,
wherein the questions regarding scenarios related to healthcare communications comprise questions regarding application of regulatory guidelines to public relations, advertising and medical education, or compliance scenarios;
wherein the compliance scenarios comprise advocacy group relationships, speaker's bureaus and publication strategies, off-label communication around medical meetings, communications in support of clinical trials, corporate integrity agreements, or the False Claims Act.

15. A computer program product according to claim 1, wherein said computer readable program code embodied in said medium further causes said computer to execute via an online portal a method of identifying and filling gaps in creating a culture of compliance with healthcare communications regulations and policies in an organization, comprising:
receiving data and information related to an organization's healthcare communications;
analyzing said data and information based on guidelines for identifying and filling gaps in creating a culture of compliance with healthcare communications regulations and policies in an organization; and
performing internal material audits on said data and information.

16. A computer program product according to claim 15,
transmitting said data and information to professionals with expertise in identifying and filling gaps in creating said culture of compliance with healthcare communications regulations and policies in an organization;
receiving solutions from said professionals for solving said gaps; and
displaying said solutions.

17. A computer program product according to claim 1, wherein said computer readable program code embodied in said medium further causes said computer to execute via an online portal a method for transmitting training information, comprising:
receiving healthcare communications training information; and
displaying said information.

18. A computer program product according to claim 17,
wherein said training information comprises web-based training seminars taught by leaders in the field of healthcare communications.

19. A computer program product according to claim 18, further comprising:
receiving questions regarding said healthcare communications training information; and
displaying answers to said questions.

20. A computer program product according to claim 17, further comprising:
determining specific areas of said healthcare communications training information required by a certain healthcare communications organization;
limiting said healthcare communications training information to said specific areas; and
displaying only said healthcare communications training information limited to said specific areas.

21. A computer program product according to claim 1, wherein said computer readable program code embodied in said medium further causes said computer to execute via an online portal a method for accessing information related to healthcare communications, comprising:
displaying a menu of available information related to healthcare communications, wherein said menu also contains information regarding how to access said information related to healthcare communications;
receiving a request for specific information related to healthcare communications; and
displaying said requested information.

22. A computer program product according to claim 21;
wherein said displaying step displays a hypertext link to said requested information.

23. A computer program product according to claim 21,
wherein said information related to healthcare communications comprises regulatory compliance information, regulatory body information, regulatory guidelines, regulatory standards, industry group information, industry group guidelines, industry group standards, industry group newsletters, best practices for healthcare communications professionals, common communications situations, healthcare communications presentations, healthcare communications news.

24. A computer program product according to claim 21, further comprising:
transmitting said request for specific information related to healthcare communications to a librarian;
receiving information from said librarian in response to said transmitted request; and
displaying said information received from said librarian.

25. A computer program product according to claim 22,
wherein said hypertext links includes at least one of: http://www.fda.gov, http://www.fda.gov/cder/warn/index.htm;
http://www.fda.gov/cder/ddmac/lawsregs.htm;
http://www.access.gpo.gov/nara/cfr/waisidx_{—}01/21cfr202_{—}01.html;
http://www.accessdata.fda.gov/scripts/w1cfm/sindex.cfm;
http://www.accessdata.fda.gov/scripts/w1cfm/cindex.cfm;
http://www.fda.gov/cber/efoi/adpromo.htm, and links to OIG (Office of the Inspector General of HHS) and ACCME (Accreditation Council for Continuing Medical Education).

26. A computer program product according to claim 23,
wherein said industry groups comprise PhRMA (Pharmaceutical Research and Manufacturers of America); Advanced Medical Technology Association (AdvaMed); Food and Drug Law Institute (FDLI), Drug Information Association (DIA); and Regulatory Affairs Professionals Association (RAPS).

27. A computer program product according to claim 1, wherein said computer readable program code embodied in said medium further cause said computer to execute via an online portal a method for publishing industry benchmark reports, comprising:
a step of publishing industry benchmark reports, wherein said publishing comprises displaying said reports.

28. A computer program product according to claim 1, wherein said computer readable program code embodied in said medium further cause said computer to execute via an online portal a method for making grants, comprising:
displaying a menu of available third-party organizations in correspondence with information regarding grants that can be made to said organizations;
receiving a request to make a grant to a third-party organization; and
transmitting said grant.

29. A computer program product according to claim 28,
wherein said third-party organizations comprise universities, industry groups, and professional associations.

30. An online portal system for accessing a database of resources, comprising:
a processing unit configured to access one or more individual resources in said database; and
a user interface that interactively provides access to said resources,
wherein each resource contains information related to healthcare communications where said information comprises regulatory compliance information, regulatory body information, regulatory guidelines, regulatory standards, industry group information, industry group guidelines, industry group standards, industry group newsletters, best practices for healthcare communications professionals, common communications situations, healthcare communications presentations, healthcare communications news.
